(19) United States
(12) Patent Application Publication
(10) Pub. No.: US 2023/0206098 A1
(43) Pub. Date: Jun. 29, 2023

(54) INTELLIGENT INVENTORY MANAGEMENT USING PROBABILISTIC ORDER FULFILLMENT ROUTING IN E-COMMERCE SYSTEMS

(71) Applicant: SAP SE, Walldorf (DE)

(72) Inventor: Ahmad Hassan, Maidenhead (GB)

(21) Appl. No.: 17/645,801

(22) Filed: Dec. 23, 2021

(51) Int. Cl. G06N 7/00; G06Q 10/08; G06Q 30/06

(52) U.S. Cl. CPC G06N 7/005; G06Q 10/087; G06Q 30/0635

(57) ABSTRACT

Methods, systems, and computer-readable storage media for receiving queue data, the queue data including a set of products to be fulfilled by the e-commerce system, determining market share data indicating a market share for each fulfillment location in a set of fulfillment locations, providing a set of distributions, each distribution indicating a proportion of products in the set of products to be fulfilled by a respective fulfillment location of the set of fulfillment locations, processing the market share data and the queue data through a multinomial probability model to determine, for each distribution in the set of distributions, a probability, each probability indicating a percentage of order fulfillments expected to be successfully executed for a respective distribution, selecting a distribution from the set of distributions, and fulfilling orders of the set of products using the distribution.

### BACKGROUND

Enterprises seek continuous improvement of their operations. Efficiencies gained at each step can have a significant impact on the performance of the enterprise. One challenge includes fulfilling customer orders. Order fulfillment generally includes delivering one or more goods ordered by a customer from a fulfillment center (e.g., a warehouse).

The move to online, electronic commerce (e-commerce) systems presents numerous technical challenges in the order fulfillment context. For example, prior to e-commerce systems, order fulfillment was regionalized with orders being fulfilled from a relatively local fulfillment center with respect to customers. The move to e-commerce systems nationalized and internationalized order fulfillment. That is, instead of customers being regional customers, e-commerce systems have expanded customer pools to the national and international levels.

To handle order fulfillment, e-commerce systems have traditionally implemented a rules-based approach. More particularly, enterprises define a set of rules to determine which fulfillment center will fulfill which order. This has been achieved through computer-implemented modeling based on historical fulfillment. For example, data mining techniques have been used to extract rules from massive data sets, the rules collectively modeling order fulfillment. For example, historical data can indicate products delivered from disparate fulfillment centers and respective delivery times and associated costs. Such rules typically include priority-based rules, in which fulfillment centers are ranked by priority, orders being fulfilled from the highest priority fulfillment center first.

Such a rules-based approach, however, presents significant technical challenges. For example, data mining can be time- and computing-resource intensive, as massive amounts of data need to be processed to provide robust, accurate rules. Consequently, technical infrastructure (e.g., processors, memory) need to be committed to determine rules. Further, rules are relatively static and are only periodically updated to consider changes in market and/or customer behavior. This is, at least in part, due to the required expenditure of time and technical resources to update the rules, as noted above. However, this results in the rules being outdated in dynamic scenarios and unable to keep up with relatively rapid changes in the market and/or customer behavior. For example, the onset of the coronavirus pandemic very quickly and very significantly changed the market and customer behavior in terms of e-commerce. The online demand for products spiked, the customer base rapidly increased, and the variety of products purchased expanded. The traditional rules-based approach could not keep up with such rapid change and problems arose in trying to fulfill orders in a new world with rules developed for an old world.

### SUMMARY

Implementations of the present disclosure are generally directed to an intelligent inventory management system for electronic commerce (e-commerce) systems. More particularly, implementations of the present disclosure are directed to an intelligent inventory management system that uses probabilistic order fulfillment routing to fulfill orders from a set of fulfillment centers in e-commerce systems.

In some implementations, actions include receiving queue data, the queue data including a set of products to be fulfilled by the e-commerce system, determining market share data indicating a market share for each fulfillment location in a set of fulfillment locations, providing a set of distributions, each distribution indicating a proportion of products in the set of products to be fulfilled by a respective fulfillment location of the set of fulfillment locations, processing the market share data and the queue data through a multinomial probability model to determine, for each distribution in the set of distributions, a probability, each probability indicating a percentage of order fulfillments expected to be successfully executed for a respective distribution, selecting a distribution from the set of distributions, and fulfilling orders of the set of products using the distribution. Other implementations of this aspect include corresponding systems, apparatus, and computer programs, configured to perform the actions of the methods, encoded on computer storage devices.

These and other implementations can each optionally include one or more of the following features: selecting a distribution from the set of distributions includes determining a highest probability in the set of probabilities and selecting the distribution in response to the distribution being associated with the highest probability; fulfilling orders of the set of products using the distribution includes transmitting instructions to respective fulfillment locations in the set of fulfillment locations, and delivering, from each fulfillment location, a respective proportion of products based on the distribution; distributions in the set of distributions are determined by an intelligent inventory management module of the e-commerce system; the market share data includes data indicating historical order fulfillments of respective fulfillment locations in the set of fulfillment locations; a number of products in the set of products is provided as a periodic value; and selecting a distribution from the set of distributions includes determining that two or more distributions are each associated with a probability that is a highest probability of the set of distributions and, in response, selecting the distribution as a highest priority distribution between the two or more distributions.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts a conceptual architecture depicting order fulfillment in accordance with implementations of the present disclosure.

FIG. 3 an example process that can be executed in accordance with implementations of the present disclosure.

FIG. 4 is a schematic illustration of example computer systems that can be used to execute implementations of the present disclosure.

Like reference symbols in the various drawings indicate like elements.

### DETAILED DESCRIPTION

Implementations of the present disclosure are generally directed to an intelligent inventory management system for electronic commerce (e-commerce) systems. More particularly, implementations of the present disclosure are directed to an intelligent inventory management system that uses probabilistic order fulfillment routing to fulfill orders from a set of fulfillment centers in e-commerce systems. Implementations can include actions of receiving queue data, the queue data including a set of products to be fulfilled by the e-commerce system, determining market share data indicating a market share for each fulfillment location in a set of fulfillment locations, providing a set of distributions, each distribution indicating a proportion of products in the set of products to be fulfilled by a respective fulfillment location of the set of fulfillment locations, processing the market share data and the queue data through a multinomial probability model to determine, for each distribution in the set of distributions, a probability, each probability indicating a percentage of order fulfillments expected to be successfully executed for a respective distribution, selecting a distribution from the set of distributions, and fulfilling orders of the set of products using the distribution.

To provide context for implementations of the present disclosure, and as introduced above, the order fulfillment journey of the product lifecycle in e-commerce systems accounts for multiple parameters in shipping. Example parameters include, without limitation, distance between customer address and fulfillment location(s), cost, stock limits, division, and miss-picks. Use cases of order fulfillment can be categorized into finding a fulfillment location with the highest probability to fulfill the order, while keeping the keeping key performance indicators (KPIs) of the e-commerce system high, or splitting the order across multiple fulfillment locations, if one fulfillment location cannot service the order.

Overall, order fulfillment is a key challenge for e-commerce systems where an enterprise determines how to ship product(s) to customers and which fulfillment location(s) to choose to ship the product(s) from. Order fulfillment has its own inherent challenges. For example, orders can get cancelled or delayed due to out of stock products at certain fulfillment locations. As another example, orders are improperly fulfilled, which is referred to as a miss-pick. An improper selection of fulfillment location can also trigger the problem of back orders building up within the e-commerce system. Overall, if a fulfillment location cannot fulfill the whole order or can only partially fulfill the order, poor inventory management arises and order delivery delays incur.

Traditionally, e-commerce systems have implemented a rules-based approach, in which a set of rules is used to determine which fulfillment center will fulfill which order. This has been achieved through computer-implemented modeling based on historical fulfillment. For example, data mining techniques have been used to extract rules from massive data sets, the rules collectively modeling order fulfillment. For example, historical data can indicate products delivered from disparate fulfillment centers and respective delivery times and associated costs. Such rules typically include priority-based rules, in which fulfillment centers are ranked by priority, orders being fulfilled from the highest priority fulfillment center first.

Such a rules-based approach, however, presents significant technical challenges. For example, data mining can be time- and computing-resource intensive, as massive amounts of data need to be processed to provide robust, accurate rules. Consequently, technical infrastructure (e.g., processors, memory) need to be committed to determine rules. Further, rules are relatively static and are only periodically updated to consider changes in market and/or customer behavior. This is, at least in part, due to the required expenditure of time and technical resources to update the rules, as noted above. However, this results in the rules being outdated in dynamic scenarios and unable to keep up with relatively rapid changes in the market and/or customer behavior. Consequently, the traditional rules-based approach not only presents technical challenges, but can also result in order delay, order cancellation, back-orders, and the like, discussed above.

In view of the above context, implementations of the present disclosure an intelligent inventory management system that uses probabilistic order fulfillment routing to fulfill orders from a set of fulfillment centers in e-commerce systems. As described herein, the intelligent inventory management system obviates the need for resource- and time-intensive data mining to develop and update rules. More particularly, the probabilistic order fulfillment routing of the present disclosure is an alternative to traditional rules-based approaches that obviates resource expenditure and overcomes problems inherent in order fulfillment, such as those discussed herein.

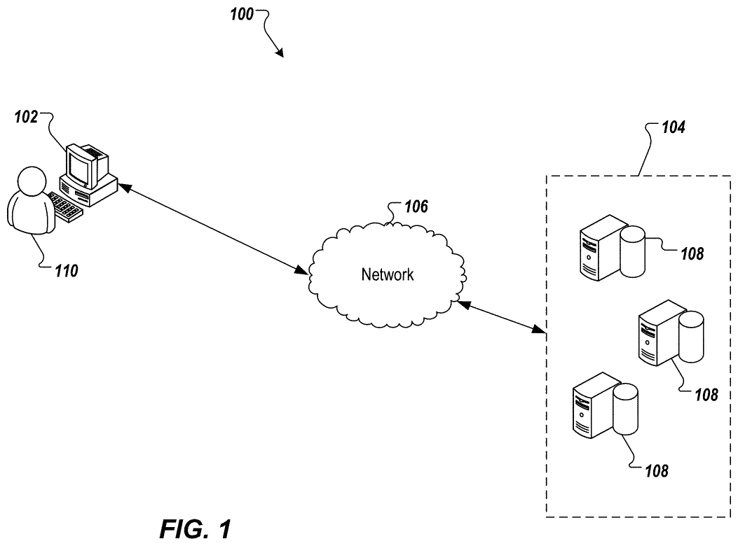

FIG. 1 depicts an example architecture 100 that can be used to execute implementations of the present disclosure. In the depicted example, the example architecture 100 includes one or more client devices 102, a server system 104 and a network 106. The server system 104 includes one or more server devices 108. In the depicted example, a user 110 interacts with the client device 102. In an example context, the user 110 can include a user, who interacts with an application that is hosted by the server system 104.

In some examples, the client device 102 can communicate with one or more of the server devices 108 over the network 106. In some examples, the client device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, each server device 108 includes at least one server and at least one data store. In the example of FIG. 1, the server devices 108 are intended to represent various forms of servers including, but not limited to a web server, an application server, a proxy server, a network server, and/or a server pool. In general, server systems accept requests for application services and provides such services to any number of client devices (e.g., the client device 102) over the network 106.

In accordance with implementations of the present disclosure, the server system 104 can host an e-commerce system that includes an intelligent inventory management system or the present disclosure. For example, and as described in further detail herein, the e-commerce system can include an intelligent inventor management system of the present disclosure to dynamically determine distributions of products across a set of fulfillment centers for order fulfillment. As described in further detail herein, the intelligent inventor management system determines a distribution of products across the fulfillment centers to achieve an optimized order fulfillment and successfully execute a highest number of order fulfillments (e.g., orders being shipped to users on time).

As introduced above, implementations of the present disclosure provide an intelligent inventory management system that uses probabilistic modeling to address order fulfillment as an alternative to traditional rule-based approaches. In probabilistic modeling, a case can be considered, in which sampling with replacement (SwR) is used to select a sample of a product from a set of products. SwR can be described as maintaining the sample size static for each sampling. For example, a set of products can include 5 products. A first sample can be taken by randomly selecting a product from the set of products, each product having a 1/5 chance of being selected. Upon sampling, the product is replaced in the set of products. A second sample can be taken by randomly selecting a product from the set of products, each product still having a 1/5 chance of being selected. In contrast, sampling without replacement (SwoR) can be described as the sample size changing for each sampling. For example, a set of products can include 5 products. A first sample can be taken by randomly selecting a product from the set of products, each product having a 1/5 chance of being selected. Upon sampling, the product is not replaced in the set of products. A second sample can be taken by randomly selecting a product from the set of products, each product now having a 1/4 chance of being selected.

In the above context, the following example relationship can be provided:

$${P}_{j} = \frac{{n}_{j}}{N} \qquad ( 1 )$$

where Pⱼ is the probability of the j^{th} product being selected, j=1, 2, 3, . . . k and N is a set of products {n₁, . . . , nₖ}. In the context of implementations of the present disclosure, Equation 1 represents the probability of the j^{th} product being purchased through an e-commerce system. Accordingly, the total probability is provided as:

Σⱼ₌₁^{k}Pⱼ=1 (2)

In some examples, products can be considered in groups (x). For example, a group of product n₁ can be denoted as x₁, a group of product n₂ can be denoted as x₂, and a group of product nₖ can be denoted as xₖ. For example:

$$\{ \begin{matrix}{x}_{1} of product {n}_{1} \\ {x}_{2} of product {n}_{2} \\ … \\ {x}_{k} of product {n}_{k}\end{matrix} \} \qquad ( 3 )$$

Each group of products can be provided from a product store (e.g., a store of the respective product). In this sense, each store can be described as of a type reflective of the respective product. For example, a store of product n₁ can be described as being of type 1, a store of product n₂ can be described as being of type 2, and a store of product nₖ can be described as being of type k.

By independence, the probability of drawing x₁ number of products n₁ from the store of type 1, x₂ number of products n₂ from the store of type 2, and so on to xₖ number of products nₖ from the store of type k can be provided as:

(p₁)^{(x}^{₁}⁾,(p₂)^{(x}^{₂}⁾, . . . ,(pₖ)^{(x}^{ₖ}⁾ (4)

The number of different ways of choosing x₁ number of products n₁ from the store of type 1, x₂ number of products n₂ from the store of type 2, and so on to xₖ number of products nₖ from the store of type k can be calculated as:

$$\frac{n !}{{x}_{1} ! {x}_{2} ! … {x}_{k} !} \qquad ( 5 )$$

where:

Σⱼ₌₁^{k}xⱼ=n (6)

Accordingly, a multinomial probability can be provided as:

$$P ( {X}_{1} = {x}_{1} , {X}_{2} = {x}_{2} , … , {X}_{k} = {x}_{k} ) = \frac{n !}{{x}_{1} ! {x}_{2} ! … {x}_{k} !} {\prod }_{j = 1}^{k} {P}_{j}^{( {x}_{j} )} \qquad ( 7 )$$

where 0≤xⱼ≤n. Equation 7 provides a multinomial probability model. If N is large, SwR and SwoR are relatively equivalent for at least an initial number of samples. For example, if N includes 10,000 products, for a first sample, each product has a 1/10,000 chance of being selected. For a second sample, each product has a 1/10,000 chance of being selected under SwR and a 1/9,999 chance of being selected under SwoR. In view of this, Equation 7 can be expressed as:

$${P}_{l} ( {X}_{1} = {x}_{1} , {X}_{2} = {x}_{2} , … , {X}_{k} = {x}_{k} ) = {P}_{l} ( X ) = \frac{n !}{{\prod }_{i = 1}^{k} {x}_{i} !} {\prod }_{j = 1}^{k} {P}_{j}^{( {x}_{j} )} \qquad ( 8 )$$

Equation 8 assumes that there are/data stores that contain the product inventory and the products are shared among the multiple brands of the same enterprise. The proposed mixture multinomial distribution for multiple stores (data centers) of an enterprise is provided as:

P(X)=Σ_{L=1}^{m}αₗ*Pₗ^{(X)} (9)

where αₗ is the proportion of the l'th store and Σ_{L=1}^{m}αₗ=1. Pₗ^{(X)} is provided from equation (8). αₗ represents the individual data stores.

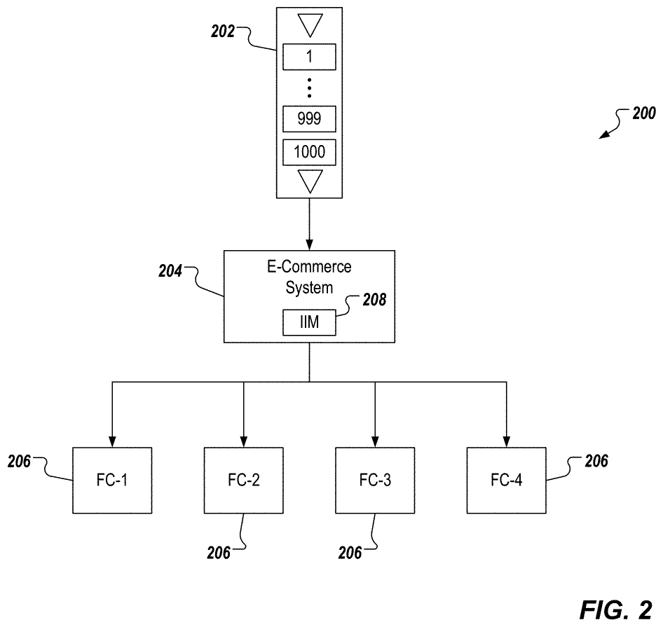

FIG. 2 depicts a conceptual architecture 200 depicting order fulfillment in accordance with implementations of the present disclosure. In the example of FIG. 2, the conceptual architecture 200 includes a user queue 202, an e-commerce system 204, and multiple fulfillment centers 206 (e.g., FC-1, FC-2, FC-3, FC-4). In this example, an enterprise, which markets products through the e-commerce system 204, has four fulfillment centers. Users in the user queue 202 interact with the e-commerce system 204 to purchase products, which are fulfilled from one or more of the fulfillment centers 206. In some examples, the user queue 202 indicates a queue of products that are expected to be purchases (e.g., 1000 products in the example of FIG. 2). In some examples, the enterprise determines the distribution length (queue). For example, the enterprise can set the distribution length based on a pre-defined period (e.g., weekly, monthly) or any appropriate value of n (see Equation 6) (e.g., based on demand). In some examples, a first distribution can be provided using a first value of n, and a second distribution can be provided using a second value of n in an effort to optimize (e.g., based on feedback).

In the example of FIG. 2, the e-commerce system 204 includes an intelligent inventory management (IIM) module 208 that determines a distribution of products across the fulfillment centers 206 to achieve an optimized order fulfillment. More particularly, and as described in further detail herein, the IIM module 208 processes a set of distributions through the probabilistic order fulfillment routing model of the present disclosure to determine which products are to be fulfilled from which fulfilled from which fulfillment locations 206 to achieve the highest percentage of order fulfillment (e.g., orders being shipped to users on time) for the given scenario.

In accordance with implementations of the present disclosure, for each user queue 202, a distribution of products across the fulfillment centers 206 can be selected to optimize order fulfillment (e.g., orders being shipped to users on time). For example, a set of distributions can be determined, and each distribution can be processed by the IIM module 208 to determine a set of probabilities. Each probability in the set of probabilities corresponds to a respective distribution in the set of distributions and indicates, for the respective distribution, the percentage of orders that would be fulfilled. In some examples, the distribution corresponding to the highest probability is selected.

For purposes of illustration, implementations of the present disclosure are described in further detail herein with respect to example values. It is contemplated, however, that implementations of the present disclosure can be realized using any appropriate values.

For purposes of non-limiting illustration, it can be determined that there are 1000 products in the queue 202. That is, for example, it can be determined that, given the current number of users, 1000 products are expected to be ordered through the e-commerce system 204. It can also be determined that the fulfillment locations 206 have market shares of 15%, 40%, 25%, and 20%, respectively (i.e., FL-1, FL-2, FL-3, FL-4). In some examples, the market shares are provided from historical data indicating demand fulfillments from respective fulfillment locations 206. A set of distributions can be provided by the IIM module 208 for the 1000 products. Example distributions can be provided as:

TABLE 1
Example Set of Distributions

| Distribution | FL-1 | FL-2 | FL-3 | FL-4 |
|---|---|---|---|---|
| A | 1000 | 0 | 0 | 0 |
| B | 0 | 1000 | 0 | 0 |
| C | 0 | 0 | 1000 | 0 |
| D | 0 | 0 | 0 | 1000 |
| E | 250 | 250 | 250 | 250 |
| F | 400 | 300 | 200 | 100 |
| G | 100 | 200 | 300 | 400 |

For each distribution, a probability is determined by the IIM module 208. For example, the IIM module 208 processes each distribution and the market share data through the probabilistic order fulfillment routing model of the present disclosure to determine a probability for each distribution. For example, the probability for distributions E and F (P_{E}, P_{F}, respectively) of Table 1 are respectively determined as:

$${P}_{E} ( {X}_{1} = 250 , {X}_{2} = 250 , {X}_{3} = 250 , {X}_{4} = 250 ) = \frac{1000 !}{250 ! 250 ! 250 ! 250 !} {( 0.15 )}^{250} {( 0.4 )}^{250} {( 0.25 )}^{250} {( 0.2 )}^{250} = 7.02 e - 34 \\ {P}_{F} ( {X}_{1} = 400 , {X}_{2} = 300 , {X}_{3} = 200 , {X}_{4} = 100 ) = \frac{1000 !}{400 ! 300 ! 200 ! 100 !} {( 0.15 )}^{400} {( 0.4 )}^{300} {( 0.25 )}^{200} {( 0.2 )}^{100} = 1.55 e - 88$$

Accordingly, and for the example set of distributions of Table 1, the following example probabilities can be provided:

TABLE 2
Example Set of Distributions and Probabilities

| Distribution | FL-1 | FL-2 | FL-3 | FL-4 | Prob (P) |
|---|---|---|---|---|---|
| A | 1000 | 0 | 0 | 0 | 0.99 |
| B | 0 | 1000 | 0 | 0 | 0.99 |
| C | 0 | 0 | 1000 | 0 | 0.99 |
| D | 0 | 0 | 0 | 1000 | 0.99 |
| E | 250 | 250 | 250 | 250 | 7.02e−34 |
| F | 400 | 300 | 200 | 100 | 1.55e−88 |
| G | 100 | 200 | 300 | 400 | 1.82e−71 |
| H | 4 | 3 | 2 | 1 | 0.005 |

In the example of FIG. 2, it can be determined that the distributions A-D provide the highest probability of order fulfillment. That is, in this example, any of the distributions A-D would result in 99% order fulfillment. Consequently, one of the distributions A-D can be selected as the distribution that is to be used to fulfill the orders. In some examples, a distribution can be selected based on prioritized order of otherwise equivalent distributions. For example, and with reference to the examples of Table 2, distribution A can be selected based on the fulfillment location FL-1 being a highest prioritized fulfillment location.

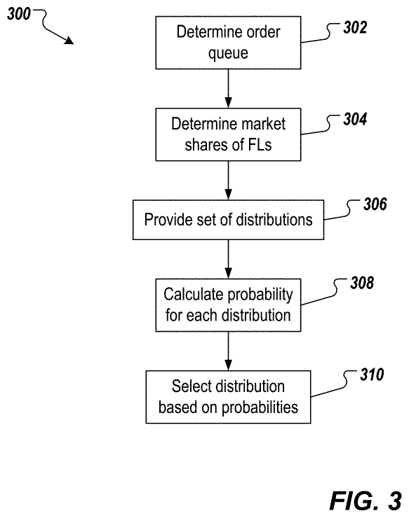

FIG. 3 depicts an example process 300 that can be executed in accordance with implementations of the present disclosure. In some examples, the example process 300 can be provided by one or more computer-executable programs executed using one or more computing devices. The example process 300 can be performed to provide associations between products in accordance with implementations of the present disclosure.

A order queue is determined (302). For example, and as described herein, the order queue (distribution length) is determined based on a pre-defined period (e.g., weekly, monthly) or any appropriate value of n (see Equation 6) (e.g., based on demand). In some examples, the order queue is determined as an adjustment from a first value of n to a second value of n in an effort to optimize from an earlier iteration (e.g., based on feedback). Market shares of respective fulfillment locations (FLs) are determined (304). For example, and as described herein, the market shares are provided from historical data indicating demand fulfillments from respective fulfillment locations.

A set of distributions is provided (306). For example, and as described herein, the set of distributions can be determined by the enterprise, each distribution having differing values for each of the fulfillment locations. Each distribution can represent a potential distribution that can be used for order fulfillment. A probability is determined for each distribution (308). For example, and as described herein, values of each distribution in the set of distributions and respective market shares of the fulfillment locations are processed (e.g., through Equation 7) to determine respective probabilities. A distribution is selected based on the probabilities (310). For example, and as described herein, a distribution having a highest probability of the probabilities is selected for order fulfillment. In some examples, if two or more distributions are each associated with a probability that is a highest probability of the set of distributions, a distribution that is a highest priority distribution between the two or more distributions can be selected.

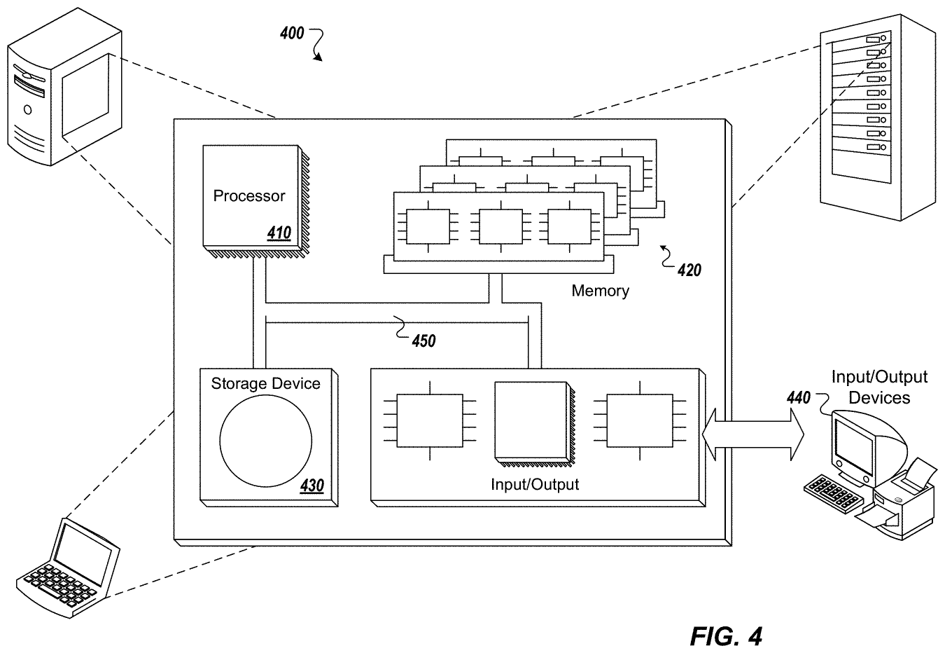

Referring now to FIG. 4, a schematic diagram of an example computing system 400 is provided. The system 400 can be used for the operations described in association with the implementations described herein. For example, the system 400 may be included in any or all of the server components discussed herein. The system 400 includes a processor 410, a memory 420, a storage device 430, and an input/output device 440. The components 410, 420, 430, 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit. The storage device 430 is capable of providing mass storage for the system 400. In one implementation, the storage device 430 is a computer-readable medium. In various different implementations, the storage device 430 may be a floppy disk device, a hard disk device, an optical disk device, or a tape device. The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for order fulfillment in electronic commerce (e-commerce) systems, the method being executed by one or more processors and comprising:
receiving queue data, the queue data comprising a set of products to be fulfilled by the e-commerce system;
determining market share data indicating a market share for each fulfillment location in a set of fulfillment locations;
providing a set of distributions, each distribution indicating a proportion of products in the set of products to be fulfilled by a respective fulfillment location of the set of fulfillment locations;
processing the market share data and the queue data through a multinomial probability model to determine, for each distribution in the set of distributions, a probability, each probability indicating a percentage of order fulfillments expected to be successfully executed for a respective distribution;
selecting a distribution from the set of distributions; and
fulfilling orders of the set of products using the distribution.

2. The method of claim 1, wherein selecting a distribution from the set of distributions comprises determining a highest probability in the set of probabilities and selecting the distribution in response to the distribution being associated with the highest probability.

3. The method of claim 1, wherein fulfilling orders of the set of products using the distribution comprises transmitting instructions to respective fulfillment locations in the set of fulfillment locations, and delivering, from each fulfillment location, a respective proportion of products based on the distribution.

4. The method of claim 1, wherein distributions in the set of distributions are determined by an intelligent inventory management module of the e-commerce system.

5. The method of claim 1, wherein the market share data comprises data indicating historical order fulfillments of respective fulfillment locations in the set of fulfillment locations.

6. The method of claim 1, wherein a number of products in the set of products is provided as a periodic value.

7. The method of claim 1, wherein selecting a distribution from the set of distributions comprises determining that two or more distributions are each associated with a probability that is a highest probability of the set of distributions and, in response, selecting the distribution as a highest priority distribution between the two or more distributions.

8. A non-transitory computer-readable storage medium coupled to one or more processors and having instructions stored thereon which, when executed by the one or more processors, cause the one or more processors to perform operations for order fulfillment in electronic commerce (e-commerce) systems, the operations comprising:
receiving queue data, the queue data comprising a set of products to be fulfilled by the e-commerce system;
determining market share data indicating a market share for each fulfillment location in a set of fulfillment locations;
providing a set of distributions, each distribution indicating a proportion of products in the set of products to be fulfilled by a respective fulfillment location of the set of fulfillment locations;
processing the market share data and the queue data through a multinomial probability model to determine, for each distribution in the set of distributions, a probability, each probability indicating a percentage of order fulfillments expected to be successfully executed for a respective distribution;
selecting a distribution from the set of distributions; and
fulfilling orders of the set of products using the distribution.

9. The non-transitory computer-readable storage medium of claim 8, wherein selecting a distribution from the set of distributions comprises determining a highest probability in the set of probabilities and selecting the distribution in response to the distribution being associated with the highest probability.

10. The non-transitory computer-readable storage medium of claim 8, wherein fulfilling orders of the set of products using the distribution comprises transmitting instructions to respective fulfillment locations in the set of fulfillment locations, and delivering, from each fulfillment location, a respective proportion of products based on the distribution.

11. The non-transitory computer-readable storage medium of claim 8, wherein distributions in the set of distributions are determined by an intelligent inventory management module of the e-commerce system.

12. The non-transitory computer-readable storage medium of claim 8, wherein the market share data comprises data indicating historical order fulfillments of respective fulfillment locations in the set of fulfillment locations.

13. The non-transitory computer-readable storage medium of claim 8, wherein a number of products in the set of products is provided as a periodic value.

14. The non-transitory computer-readable storage medium of claim 8, wherein selecting a distribution from the set of distributions comprises determining that two or more distributions are each associated with a probability that is a highest probability of the set of distributions and, in response, selecting the distribution as a highest priority distribution between the two or more distributions.

15. A system, comprising:
a computing device; and
a computer-readable storage device coupled to the computing device and having instructions stored thereon which, when executed by the computing device, cause the computing device to perform operations for order fulfillment in electronic commerce (e-commerce) systems, the operations comprising:
receiving queue data, the queue data comprising a set of products to be fulfilled by the e-commerce system;
determining market share data indicating a market share for each fulfillment location in a set of fulfillment locations;
providing a set of distributions, each distribution indicating a proportion of products in the set of products to be fulfilled by a respective fulfillment location of the set of fulfillment locations;
processing the market share data and the queue data through a multinomial probability model to determine, for each distribution in the set of distributions, a probability, each probability indicating a percentage of order fulfillments expected to be successfully executed for a respective distribution;
selecting a distribution from the set of distributions; and
fulfilling orders of the set of products using the distribution.

16. The system of claim 15, wherein selecting a distribution from the set of distributions comprises determining a highest probability in the set of probabilities and selecting the distribution in response to the distribution being associated with the highest probability.

17. The system of claim 15, wherein fulfilling orders of the set of products using the distribution comprises transmitting instructions to respective fulfillment locations in the set of fulfillment locations, and delivering, from each fulfillment location, a respective proportion of products based on the distribution.

18. The system of claim 15, wherein distributions in the set of distributions are determined by an intelligent inventory management module of the e-commerce system.

19. The system of claim 15, wherein the market share data comprises data indicating historical order fulfillments of respective fulfillment locations in the set of fulfillment locations.

20. The system of claim 15, wherein a number of products in the set of products is provided as a periodic value.
